(19) United States
(12) Patent Application Publication
(10) Pub. No.: US 2026/0204046 A1
(43) Pub. Date: Jul. 16, 2026

(54) FLARE STREAM CLASSIFICATION WITH SEMANTIC SEGMENTATION AND GENERATIVE ADVERSARIAL NETWORKS IN NORMAL AND LOW-LIGHT CONDITIONS

(71) Applicant: Schlumberger Technology Corporation, Sugar Land, TX (US)

(72) Inventors: Weijia DU, Cambridge (GB); Fatma MAHFOUDH, Cambridge (GB); Josselin KHERROUBI, Clamart (FR); Julia TOGASHI DE MIRANDA, Rio de Janeiro (BR); Salma BENSLIMANE, Menlo Park, CA (US); Charles TOUSSAINT, Clamart (FR); Sebastien CATHELINE, Clamart (FR); Thibault VEXIAU, Clamart (FR)

(21) Appl. No.: 19/139,349

(22) PCT Filed: Feb. 9, 2024
(86) PCT No.: PCT/US2024/015091

§ 371 Date: Jun. 15, 2025

Related U.S. Application Data
(60) Provisional application No. 63/484,262, filed on Feb. 10, 2023.

(51) Int. Cl. G06V 10/764; F23G 7/08; G06V 10/82; G06V 20/70

(52) U.S. Cl. CPC G06V 10/764; G06V 10/82; G06V 20/70; F23G 7/08

(57) ABSTRACT

Embodiments presented provide for a testing of flare streams. Classification of flare streams are performed by artificial intelligence in normal and low-light conditions by processing visual data of the flare stream system in a computer arrangement to achieve visual data results and performing a postprocessing of the visual data results to produce postprocessing results.

### CROSS-REFERENCE TO RELATED APPLICATIONS

The present application claims priority benefit of U.S. Provisional Application No. 63/484,262, filed Feb. 10, 2023, the entirety of which is incorporated by reference herein and should be considered part of this specification.

### FIELD OF THE DISCLOSURE

Aspects of the disclosure relate to classification of flare streams used in industry. More specifically, aspects of the disclosure relate to automated intelligence systems to perform classification of flare streams in daytime and low light conditions.

### BACKGROUND

Classification of flare streams in industry is an important part of industrial processing. Flare streams are created for many purposes by industry, but the most common reason is to burn off effluents from an industrial process. The burning of these effluents prevents harmful chemicals from reaching the environment, thus flares are vital to environmental standards created for various industries.

In some embodiments, the flares are part of a system to lower or eliminate gaseous pollutants that are of concern to the general public. Effluents such as carbon monoxide, nitrous oxide and methane should be converted to other forms of gases as these greenhouse gasses can have serious impacts on society.

Reading a flare stream, conventionally, required an individual who is specifically trained to view such flare streams to determine if the flare stream is accurately performing the required task. For decades, individuals have been trained to view the differences in different flare streams to be able to distinguish problematic flare streams from properly operating ones. Such work; however, is highly subjective. Individuals differ in their view points on the same flare and may arrive at different conclusions for the same flare. It was desired; therefore, to take a more programmatic approach to classification in order to better evaluate such flare systems.

To provide more objectivity in the evaluation process, industry has attempted to place video capture systems and allow for these video capture systems to be somewhat “evaluative”. While such systems are a step in the right direction, conventional systems are prone to large errors. Errors are generated through a number of potential faults. One such fault is a “low light” condition. In low light conditions, conventional systems can not properly distinguish between normal flare operations and degraded flare operations. Often, black and white images that are obtained for processing are poorly handled. Classification; therefore, is again compromised.

Operating with a degraded flare system poses a large risk for industry. As governments seek to stem the tide of pollutants from entering the atmosphere, financial repercussions are imposed on industries that do not operate at peak efficiency. Large fines may be imposed on industries that violate standing emissions requirements. Such fines can be so serious that the viability of the company itself may be at risk.

There is a need to provide apparatus and methods that are easier to operate than conventional apparatus and methods, wherein a reliable automated system is achieved.

There is a further need to provide apparatus and methods that do not have the drawbacks discussed above, namely the need for specially trained personnel and the ability to perform analysis in low light conditions.

There is a still further need to reduce economic costs associated with operations and apparatus described above with conventional tools and to avoid fines that may be imposed on industries that are not running at peak efficiency.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are; therefore, not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method for flare stream classification is disclosed. The method may comprise obtaining visual data of a flare stream system, wherein the obtaining of the visual data is through a camera system not using infrared technology. The method may also comprise processing the visual data of the flare stream system in a computer arrangement to achieve visual data results. The method may also comprise performing a postprocessing of the visual data results to produce postprocessing results. The method may also comprise visually displaying the postprocessing results.

In another example embodiment, a method for flare stream classification is disclosed. The method may comprise, in one example embodiment, obtaining visual data of a flare stream system, wherein the obtaining of the visual data is through a camera system using infrared technology. The method may further comprise processing the visual data of the flare stream system in a computer arrangement to achieve visual data results that are colorized. The method may also comprise performing a segmentation on the visual data results that are colorized to produce segmented results. The method may also comprise performing a postprocessing on the segmented results to produce postprocessing results. The method may also comprise visually displaying the postprocessing results.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted; however, that the appended drawings illustrate only typical embodiments of this disclosure and are therefore not be considered limiting of its scope, for the disclosure may admit to other equally effective embodiments.

FIG. 1 is a flare segmentation and classification system with non-infra-red mode in one example embodiment of the disclosure.

FIG. 2 is a flare segmentation and classification system with infra-red mode in one example embodiment of the disclosure.

FIG. 3 is a schematic of Pix-2-Pix architecture in one example embodiment of the disclosure.

FIG. 4 is an example output of a segmentation algorithm applied on a generative adversarial network in one example embodiment of the disclosure.

FIG. 5 is an example method of flare stream classification without an infrared system, in accordance with one example embodiment of the disclosure.

FIG. 6 is an example method of flare stream classification with an infrared system, in accordance with one example of the disclosure.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood; however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood; however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

Aspects of the disclosure propose a deep learning, guided framework for flare (flame and smoke) classification and segmentation. This system uses real-time video flux that predicts the flare segmentation mask not only in daytime but also at night. As will be understood, night and low-light conditions pose problems for conventional systems. In embodiments, an activated infrared mode may be used to achieve classifications not possible with conventional apparatus and methods. Different types of recording of video data may be used. In some instances, a black and white (B&W) recorded image may be used. Description of this type of recorded image; however, should not be considered limiting.

In one example embodiment, aspects of the disclosure allow inferring of data on black and white recorded images. In one non-limiting aspect, these black and white images may be colored through use of a Generative Adversarial Network (GAN) prior to segmentation.

These are the main steps followed in the inference phase. In regular light levels, optics for identification and classification are satisfactory. In low light levels, optics for identification and classification may be challenged. A sensor, for example a light sensor, may be used to determine if an infrared mode is required to be used. In instances where the infrared mode is required, black and white images to be used for classification are obtained. A colored image is then generated from the black and white image. The generation of this colored image may be done through use of a Generative Adversarial Network (GAN). After the colored image is generated by the GAN, a segmentation algorithm is applied to the generated image to obtain a mask of the flame within the image. Such a mask can be performed through a deep learning model. In non-limiting embodiments, the deep learning model may be a U-Net type model. In another non-limiting embodiment, the deep learning model may be a MASK-RCNN model. Other types of deep learning, artificial intelligence models may be used. Training of the models may be performed by repetitive processing and corrective feedback performed by the modelling system. In instances where the infrared is deactivated, a segmentation mask of both the flame and smoke is predicted with a customized semantic segmentation model.

In some embodiments, a pipeline of postprocessing steps is applied on the masks to clean and smoothen the predictions. These postprocessing steps may include morphological closing and opening, which are applied on the segmentation masks. After this postprocessing, Classes (flame and smoke) are assigned after quality check validation that includes a median filter on a set of video frames.

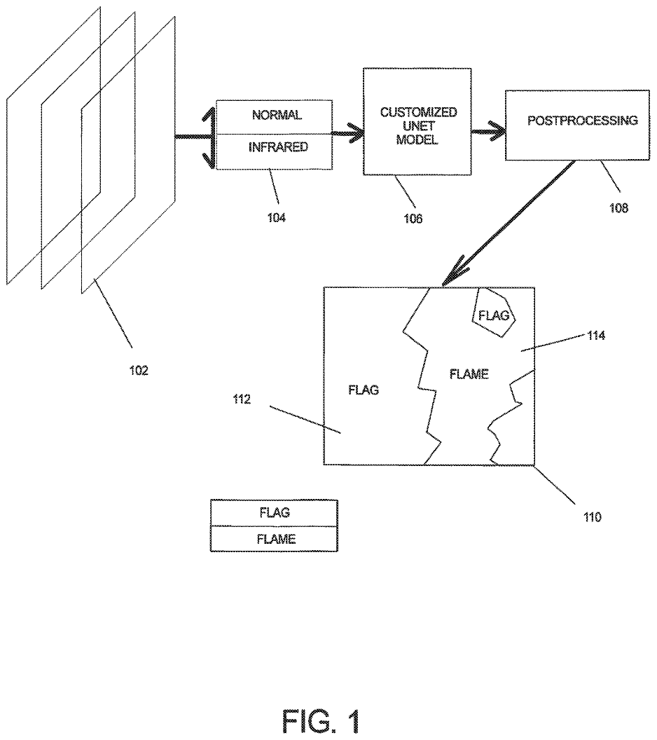

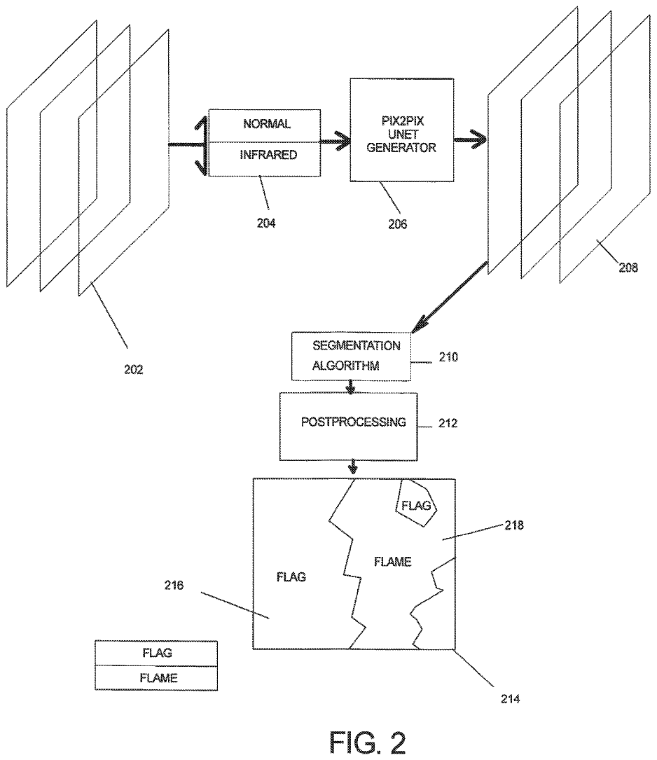

Aspects of the disclosure will be described in relation to FIGS. 1 and 2. In these embodiments an approach for detecting the presence of flame and smoke in a video flux with high reliability, independently of the mode of operation of the camera, meaning the non-infrared and infrared modes are presented. The pipelines are described in FIG. 1 and FIG. 2. Referring to FIG. 1, an embodiment of the disclosure is presented where the overall system is in a “non-infrared” mode. In this mode, pictures are taken at 102. The system is turned, at 104 to “normal” mode. Data from the pictures taken at 102 are fed into a customized UNET model at 106. The results of the customized UNET model are postprocessed at 108. The result is produced at 110, wherein areas of the image are identified as flame 114 and flag 112.

As will be understood, the processing that is performed at 106 with the customized UNET model may be done in several ways. Stand alone computers, servers or other computing mechanisms may be used in applying the model. Similarly with postprocessing at 108. The postprocessing may be on a different computing arrangement than the customized UNET model. The postprocessing 108 may also occur on the same computing arrangement as performed at 106. Results at 110 may be in the shape of images viewed by a user on a computer screen, as a non-limiting example. Results 110 may also be stored in a non-volatile memory for use at a later time. Such records from previous evaluations may be stored as evidence of continued maximum efficiency in operation of the flare system. Such records could be used, for example, with governmental officials, to provide necessary records for air quality attainment programs. Recording of visual images from the flare system may be obtained through standard equipment used in industrial plants for such purpose. In other embodiments, visual images may be obtained by specially placed visual systems. Such systems may be, as a non-limiting example, a thermal imaging camera system. Such camera systems may be capable of operating in hazardous environments. Data obtained by the camera system may be sent through a communications link, such as an ethernet cable. Data can also be sent in a parallel communications capability to a user and/or to a data storage device. Such data storage device may be internet or cloud based capable.

Referring to FIG. 2, processing steps for an infrared selected system are shown. Visual data at 202 is obtained from a camera system equipped with infrared capabilities. Such infrared capabilities may be found in standard processing facilities. Infrared capability is switched on at 204. The visual data is fed into a PIX2PIX UNET Generator at 206, thereby producing an output at 208. The output may be a colorized version of the visual data at 202. The data from 208 is then fed to a segmentation algorithm at 210 and undergoes postprocessing at 212. The results are illustrated at 214, where flame is represented at 218 and flag represented at 216.

When the infrared mode is activated at 204, the images obtained may be, for example, black and white images. These types of images are challenging for a semantic segmentation model, which provides the service of detecting flame and smoke. To aid in this task; therefore, the images taken may be colorized before segmentation occurs. This can be performed through a conditional Generative Adversarial Network.

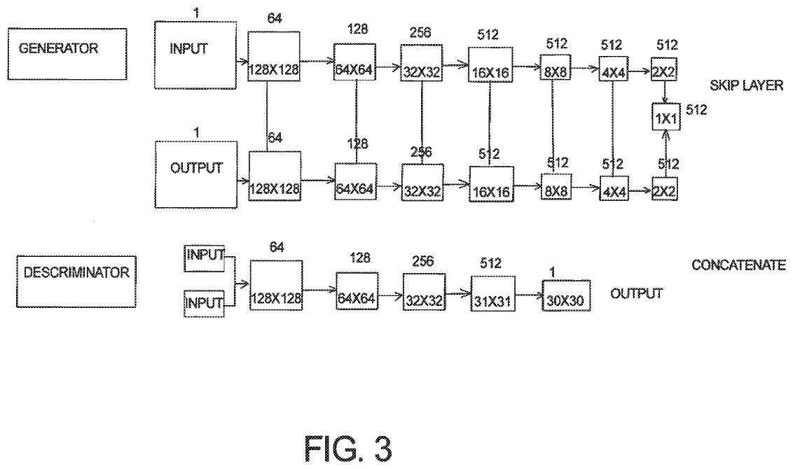

Referring to FIG. 3, the architecture for both generator and discriminator are illustrated. Both generator and discriminator are of the form convolution-Batch-Norm-ReLu. In one non-limiting embodiment, the generator has the form of a U-Net, an encoder-decoder network with added skip connections between each layer i and layer n−i, (n being the total number of layers). Each skip connection concatenates all channels of both layers as illustrated.

In embodiments, the discriminator is a denominated PatchGAN and tries to classify if each N×N patch in an image is real or fake. It is run convolutionally across the image, averaging all responses to provide the ultimate output of the discriminator.

As disclosed above, if the infrared mode is off, a semantic segmentation model is applied on the original image. In embodiments, the semantic segmentation model can be the original U-Net model or a Mask-RCNN model. As will be known, U-Net is a deep learning model that has an encoder-decoder like architecture composed of convolutional neural networks with skip connections. The encoder is pre-trained on a large, annotated image database like ImageNet. In embodiments, a complementary loss function is added to the cross entropy loss function in order to reduce the false positive rate as it is more critical than false negative rate according to the formula below.

$$Loss ( p , y ) = \frac{1}{N} {\sum }_{i = 1}^{N} {y}_{i} log ( {p}_{i} ) + {y}_{i} * {p}_{i}$$

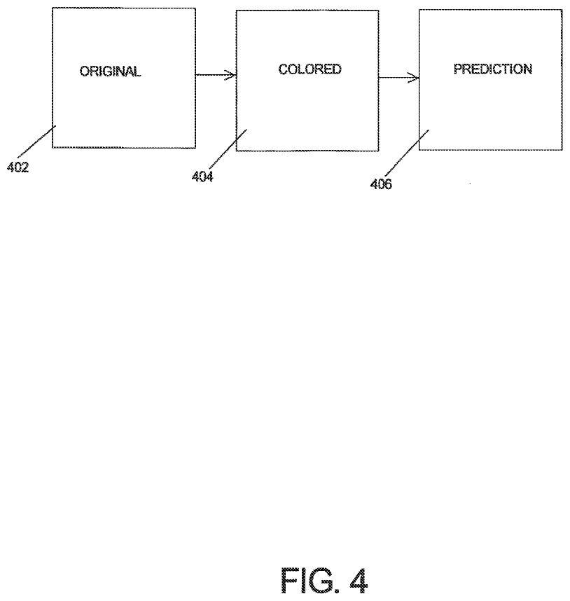

Referring to FIG. 4, the overall processing is presented, wherein original visual data is obtained, at 402. The data from 402 is then coloured at 404 then a prediction is made at 406.

In embodiments where postprocessing is performed, a higher accuracy result can be achieved. In one embodiment, computer vision techniques can use computer vision techniques. Such computer vision techniques can be, for example, morphological opening and closing. In some embodiments, a filter may be used.

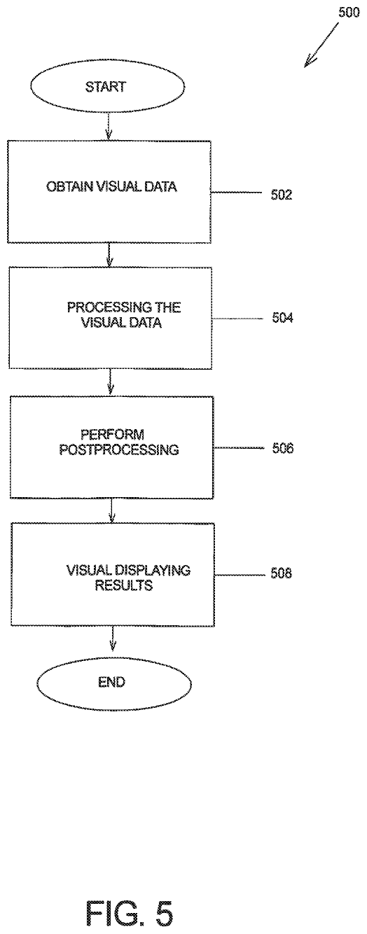

Referring to FIG. 5, a method 500 is illustrated. A method 500 may comprise, at 502, obtaining visual data of a flare stream system, wherein the obtaining of the visual data is through a camera system not using infrared technology. The method 500 may further comprise, at 504, processing the visual data of the flare stream system in a computer arrangement to achieve visual data results. The method 500 may also comprise, at 506, performing a postprocessing of the visual data results to produce postprocessing results. The method 500 may also comprise, at 508, visually displaying the postprocessing results.

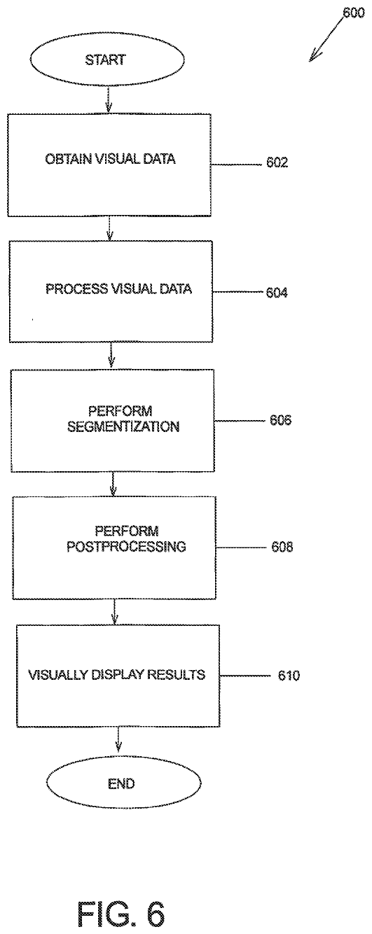

Referring to FIG. 6, a method 600 is illustrated. The method 600 may comprise, at 602, obtaining visual data of a flare stream system, wherein the obtaining of the visual data is through a camera system using infrared technology. The method 600 may also comprise, at 604, processing the visual data of the flare stream system in a computer arrangement to achieve visual data results that are colorized. The method 600 may also comprise, at 606, performing a segmentation on the visual data results that are colorized to produce segmented results. The method 600 may also comprise, at 608, performing a postprocessing on the segmented results to produce postprocessing results. The method 600 may also comprise, at 610, visually displaying the postprocessing results.

Example embodiments of the disclosure are discussed. These example embodiments should not be considered limiting. In one example embodiment, a method for flare stream classification is disclosed. The method may comprise obtaining visual data of a flare stream system, wherein the obtaining of the visual data is through a camera system not using infrared technology. The method may also comprise processing the visual data of the flare stream system in a computer arrangement to achieve visual data results. The method may also comprise performing a postprocessing of the visual data results to produce postprocessing results. The method may also comprise visually displaying the postprocessing results.

In another example embodiment, the method may further comprise saving the postprocessing results in a non-volatile memory.

In another example embodiment, the method may further comprise transmitting the obtained visual data of the flare system to the computer arrangement through a wired connection.

In another example embodiment, the method may be performed wherein the wired connection is an ethernet connection.

In another example embodiment, the method may be performed wherein the computer arrangement is one of a personal computer, a computer server and a cloud computing arrangement.

In another example embodiment, the method may be performed wherein the processing is through a U-NET visual identification architecture.

In another example embodiment, the method may be performed wherein the postprocessing is performed on a different computer arrangement than the processing of the visual data of the flare stream system.

In another example embodiment, a method for flare stream classification is disclosed. The method may comprise, in one example embodiment, obtaining visual data of a flare stream system, wherein the obtaining of the visual data is through a camera system using infrared technology. The method may further comprise processing the visual data of the flare stream system in a computer arrangement to achieve visual data results that are colorized. The method may also comprise performing a segmentation on the visual data results that are colorized to produce segmented results. The method may also comprise performing a postprocessing on the segmented results to produce postprocessing results. The method may also comprise visually displaying the postprocessing results.

In another example embodiment, the method may further comprise saving the postprocessing results in a non-volatile memory.

In another example embodiment, the method may further comprise transmitting the obtained visual data of the flare system to the computer arrangement through a wired connection.

In another example embodiment, the method may be performed wherein the wired connection is an ethernet connection.

In another example embodiment, the method may be performed wherein the computer arrangement is one of a personal computer, a computer server and a cloud computing arrangement.

In another example embodiment, the method may be performed wherein the processing is through a generative adversarial network.

In another example embodiment, the method may be performed wherein the postprocessing is performed on a different computer arrangement than the processing of the visual data of the flare stream system.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method for flare stream classification, comprising:
obtaining visual data of a flare stream system, wherein the obtaining of the visual data is through a camera system not using infrared technology;
processing the visual data of the flare stream system in a computer arrangement to achieve visual data results;
performing a postprocessing of the visual data results to produce postprocessing results; and
visually displaying the postprocessing results.

2. The method according to claim 1, further comprising saving the postprocessing results in a non-volatile memory.

3. The method according to claim 1, further comprising transmitting the obtained visual data of the flare system to the computer arrangement through a wired connection.

4. The method according to claim 1, wherein the wired connection is an ethernet connection.

5. The method according to claim 1, wherein the computer arrangement is one of a personal computer, a computer server, and a cloud computing arrangement.

6. The method according to claim 1, wherein the processing is through a U-NET visual identification architecture.

7. The method according to claim 1, wherein the postprocessing is performed on a different computer arrangement than the processing of the visual data of the flare stream system.

8. A method for flare stream classification, comprising:
obtaining visual data of a flare stream system, wherein the obtaining of the visual data is through a camera system using infrared technology;
processing the visual data of the flare stream system in a computer arrangement to achieve visual data results that are colorized;
performing a segmentation on the visual data results that are colorized to produce segmented results;
performing a postprocessing on the segmented results to produce postprocessing results; and
visually displaying the postprocessing results.

9. The method according to claim 8, further comprising saving the postprocessing results in a non-volatile memory.

10. The method according to claim 8, further comprising transmitting the obtained visual data of the flare system to the computer arrangement through a wired connection.

11. The method according to claim 8, wherein the wired connection is an ethernet connection.

12. The method according to claim 8, wherein the computer arrangement is one of a personal computer, a computer server, and a cloud computing arrangement.

13. The method according to claim 1, wherein the processing is through a generative adversarial network.

14. The method according to claim 1, wherein the postprocessing is performed on a different computer arrangement than the processing of the visual data of the flare stream system.
